(19) United States
(12) Patent Application Publication
(10) Pub. No.: US 2004/0051329 A1
(43) Pub. Date: Mar. 18, 2004

(54) Bucket liner removal device

(76) Inventor: Calvin L. Cagle, Hartsville, SC (US)

Correspondence Address: Jeffrey K. Seto, 617 Tinkerbell Rd., Chapel Hill, NC, 27517, US

(21) Appl. No.: 10/629,214

(22) Filed: Jul. 29, 2003

Related U.S. Application Data
(60) Provisional application No. 60/399,373, filed on Jul. 30, 2002.

(51) Int. Cl. B25J 15/08

(52) U.S. Cl. 294/119.1

(57) ABSTRACT

A device that is used to remove bucket liners from the insides of buckets, such as those found on bucket trucks. An elongated vice is created by a “U” shaped brace which holds a screw with a bracket located at each end of the screw. Each bracket has the cross-sectional shape of an “L” and both brackets have their lower portions pointing inward. The device is positioned above the bucket and the leading edges of the brackets are positioned between the upper lips of the bucket and the liner. The screw is turned and each bracket is forced inward until each bracket slides underneath of the liner. A lifting force, such as a forklift, is then used to lift the present device and the bucket liner, which is clamped between the brackets, out of the bucket.

### BACKGROUND OF THE INVENTION

This application was originally filed as Provisional Patent Application No. 60/399,373 on Jul. 30, 2002, and priority is hereby claimed to that application.

The present invention relates generally to the field bucket trucks and more specifically to a device for removing liners from the buckets of bucket trucks.

Bucket trucks are commonly used by fire departments and utility companies to raise men and equipment to elevated positions. Bucket trucks are commonly used by utility companies to service telephone lines and power lines that are located at the tops of telephone poles. These trucks typically have a large hydraulic lifting arm attached to the back of the truck. A large bucket for holding the men and equipment is attached to the end of the hydraulic lifting arm. Controls for moving the lifting arms are typically included on the bucket, so that the men inside the bucket can control their own movement. In order to extend the life of the buckets on these trucks, liners that are basically the same shape as the buckets, are placed inside the buckets. The liners, usually ½″ (inch) thick, absorb the shock of everyday wear and tear. When a liner wears out it is replaced with an inexpensive new liner. The liners must have a snug fit inside the bucket so that a stable platform is provided for the occupants of the bucket. Placing liners into buckets is fairly easy. However, removing a liner that has been in use inside a bucket for several months is a difficult task. A seal is formed between the bucket and the liner that is hard to break. The present invention allows for easy removal of such bucket liners.

The present invention operates in a vice like manner. A vice is a screw driven tool that is traditionally used as a clamp, to hold a piece of material while the material is worked on by a carpenter or other workman. Vices traditionally include two sides of a clamp that are connected together by a screw. One side of the clamp is a fixed side that includes a nut through which a screw passes. The other side of the clamp moves closer to the fixed side as the screw is tightened. Any item that is between the two sides of the clamp is slowly squeezed by the screwing action of the vice. Vices allow a great amount of pressure to be exerted between their clamps because of the great leverage provided by screws. The slightly inclining design of a screw allows a person to create more force, in the direction that the screw is traveling, than he would be able to with his bare hands. This increase in force is what makes vices able to hold a piece of material so securely.

### SUMMARY OF THE INVENTION

A device that is adapted to remove a liner from a bucket, wherein the liner is seated inside the bucket and at least two lips of the liner extend outwardly over the top of two opposite sides of the bucket. The device comprises a brace that is substantially in the shape of an upside down “U”. The brace includes a descending left side, a descending right side, and a transverse arm that connects the left and right sides of the brace. The device further comprises an elongated vice that is support by the left and ride sides of the brace. The elongated vice includes an elongated screw that passes through both the left and right sides of the brace. The screw has a handle at one end and threads along the opposite end. The elongated vice further includes a right bracket that is in at a position on the screw that is between the right side of the brace and the handle, and a left bracket that is attached to the threaded end of the screw at a location that is on an exterior side of the left side of the brace. The left bracket includes a nut that is secured therein and the threaded end of the screw passes through the nut. The right and left brackets are adapted to slide underneath the two lips of the liner When the handle on the screw is turned so as to tighten the elongated vice.

In the preferred embodiment, the right bracket and the left bracket each have a cross-sectional shape of an “L”, and the lower portions of both brackets point inward. The brace includes one or more attachment points, wherein each attachment point allows for attachment of a lifting force to the brace. The lifting force can be any lifting force such as a forklift or a crane. The elongated screw, the right bracket, the left bracket and the nut are each preferably made from a metal or a metal alloy.

It is an object of the present invention to provide a reliable and inexpensive means for removing liners from the buckets of bucket trucks.

### BRIEF DESCRIPTION OF THE DRAWINGS

The invention of the present application will now be described in more detail with reference to the accompanying drawings, given only by way of example, in which:

FIG. 1 shows the preferred embodiment;

FIG. 2 shows a side view of the left bracket;

FIG. 3 shows the present removal device in an operating position; and,

FIG. 4 shows the present removal device in another operating position.

### DETAILED DESCRIPTION OF THE INVENTION

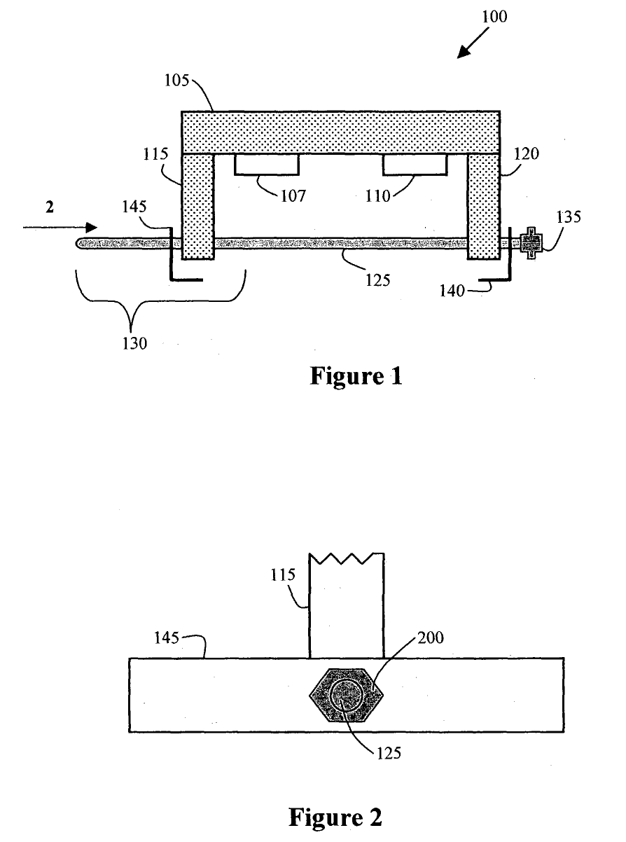

FIG. 1 shows the preferred embodiment 100 of the present bucket liner removal device. The device includes a brace in the general shape of an upside-down “U” that comprises a transverse arm 105, a descending left arm 115 and a descending right arm 120. The brace provides a fixed shape to the present specialized tool and allows the present device to act as a vice without requiring the two sides of a clamp to come in close proximity of each other. Lifting force attachment sites 107 and 110 are provided on the under side of the transverse arm 105. Attachment sites 107 and 110, in this embodiment, are designed to accept the forks of a forklift, which will be used as the lifting force. The need for a lifting force is discussed further below. Screw 125 is longer than the length of the brace and comprises a handle 135 at one end and threads at the opposite end 130. Right bracket 140, which is located between handle 135 and right arm 120, acts as one side of a clamp. Preferably, screw 125 passes through smooth holes (not threaded) in bracket 140 and right arm 120, thus screw 125 is allowed to freely slide through bracket 140 and arm 120. Descending left arm 115 also has a smooth hole through which screw 125 (130) passes and it is possible for the screw 125 to slide through the hole in arm 115 without having to turn the screw. Left bracket 145, which is located on the exterior side of left arm 115, acts as the second (fixed) side of a clamp. Left bracket 145 includes a nut (shown in FIG. 2) which engages with the threaded portion 130 of screw 125. When handle 135 is turned in a clockwise direction, screw 125 is tightened thus pulling left bracket 145 toward the interior of the brace. At the same time, right bracket 140 is also forced, by the handle 135 and the movement of the screw 125, toward the interior of the brace. Thus a vice like action occurs when the handle is turned. Of course, a spacer of a specified length can be used between handle 135 and bracket 140 in order to maintain the specified distance between the handle and the bracket. The arrow 2 in FIG. 1 shows the direction of viewing device 100 that is provided in FIG. 2.

FIG. 2 shows a side view of left arm 115, left bracket 145 and screw 125. From this view nut 200, which is preferably secured within left bracket 145, can be seen. Nut 200 is the only nut within device 100 with which the threads of screw 125 engage. In an alternative embodiment, nut 200 can be secured to the outside (left side) of bracket 145. In both embodiments, nut 200 provides the same useful purpose, that being the fixed side of a vice, so that when the screw 125 is tightened both sides of the vice (bracket 145 and bracket 140) move toward each other. The length of bracket 145 can also be seen in FIG. 2. Preferably, the length of both brackets 145 and 140 are approximately two feet long.

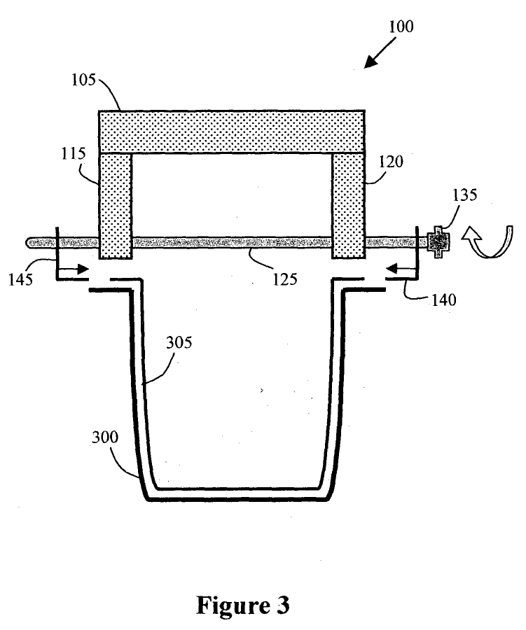

FIG. 3 shows the removal device 100 in an open operational position over the top of a bucket 300 and bucket liner 305. For clarity purposes a cross sectional view of bucket 300 and liner 305 is used in FIG. 3. As discussed above, buckets such as the one shown in FIG. 3 are commonly found on utility trucks, called bucket trucks, which have hydraulic arms for lifting the buckets. These utility trucks are used to raise men and equipment to elevated work sites, such as the tops of telephone poles. Bucket liner removal device 100 is a specialized tool that includes an elongated vice and is used for removing the liner 305 from the bucket 300. In operation, the device is placed over top of the bucket 300 and liner 305. The brackets 140 and 145 are lined up so that they are on top of the bucket 300 but not on top of the liner 305. The brackets 140 and 145 are placed outside of the outer edges of the liner 305. Typically there is a small gap between the bucket and its liner, and the brackets 140 and 145 are placed so that their leading edges fill this gap. The idea is to force the brackets 140 and 145 between the bucket 300 and liner 305 when the vice is tightened, i.e., when the handle 135 is turned. The turning of handle 135 forces screw 125 through the nut (shown in FIG. 2) in bracket 145, which results in forcing bracket 145 to the right and bracket 140 to the left. Thus a vice like action occurs when handle 135 is turned clockwise, wherein both sides of the vice, brackets 140 and 145, move toward each other. In the present case, when the vice is tightened, a great amount of force is exerted by the brackets between the bucket 300 and the liner 305. The handle is tightened until both brackets have slid underneath the upper lip of the liner 305. While the brackets have been shown with a cross-sectional shape of an “L”, the leading edge of the brackets, 140 and 145, can be tapered to provide a sharper leading edge than is shown in FIG. 3.

Device 100, in FIG. 3, is purposely shown without attachment sites. This is to show that attachment sites are not required in order to use the present device. In the embodiment of FIG. 3, the forks (or only one fork) of a forklift can be positioned directly underneath transverse arm 1 05and the forklift lifts up on transverse arm 105. This lifting force is then transferred by the descending arms, the screw and the brackets to the liner 305, and the liner 305 is lifted out of the bucket 300.

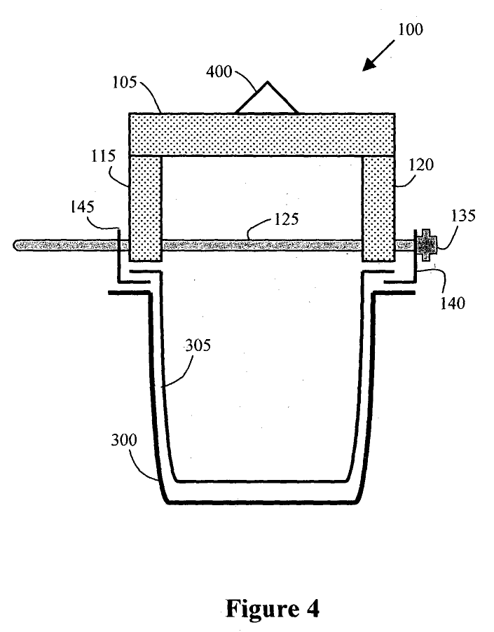

FIG. 4 shows removal device 100 in a closed operational position over the top of bucket 300 and liner 305. In the closed position, the lower portions of brackets 140 and 145 are underneath of the lip of liner 305. The present device takes advantage of the power provided by screw driven vices to break the seal that is formed between the liner 305 and the bucket 300. Once the seal is broken it is substantially easier to remove the liner 305 from the bucket 300. After the present vice has been tightened and the brackets 140 and 145 are in position under the liner 305, a lifting force is attached to the transverse arm 105 and the present device and liner 305 are lifted out of the bucket 3,00. Attachment site 400 is provided in the embodiment of FIG. 4. A crane is preferably used as the lifting force for this embodiment. A hook from the crane is hooked on to attachment site 400 and the crane is initially used to position the device 100 over the bucket 300. Then, after the present elongated vice has been tightened and the brackets have been forced underneath of liner 305, the crane is used to lift the device 100 and liner 305, which is clamped between the two brackets 140 and 145, out of the bucket 300. The bucket does not rise with the liner when the liner is pulled upward because the hydraulic arm that is attached to the bucket holds the bucket in a stationary position. As may be understood from looking at the figures, the length of the present brace should be less than the width of the bucket in order to allow the brackets to reach a position underneath of the liner. However, brackets with longer lower portions may be used with braces that are longer than the width of the bucket to make up for the difference. Once the liner 305 has been removed from the bucket 300, the handle 135 is turned in the counter clockwise direction to open the vice and the liner 305 can be removed from the removal device 100 and disposed of or recycled.

The foregoing description of the specific embodiments will so fully reveal the general nature of the invention that others can, by applying current knowledge, readily modify and/or adapt for various applications such specific embodiments without departing from the generic concept. For example, the brace could take the shape of an upside down “V” instead of an upside down “U”. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A device that is adapted to remove a liner from a bucket wherein the liner is seated inside the bucket and the liner includes at an upper lip that extend over a top of the bucket, the device comprising:
a brace that is substantially in the shape of an upside down “U”, with a descending left side, a descending right side, and a transverse connecting arm that connects the left and right sides of the brace;
an elongated screw that is support by and passes through the descending left and right sides of the brace, the elongated screw comprising a handle at one end and a threaded portion at an opposite end;
a right bracket that is between the descending right side of the brace and the handle, wherein the screw passes through a hole in a central portion of the right bracket; and,
a left bracket located on an exterior side of the left side of the brace, wherein a central portion of the left bracket includes a nut and the threaded portion of the screw passes through the nut;
wherein the right and left brackets are adapted to slide underneath opposite sides of the lip of the liner when the handle on the screw is turned in a clockwise direction.

2. The device of claim 1, wherein the right bracket and the left bracket each have a cross-sectional shape of an “L”, and lower portions of both brackets point inward.

3. The device of claim 1, wherein the brace further includes one or more attachment points, wherein each attachment point allows for attachment of a lifting force to the brace.

4. The device of claim 3, wherein the lifting force is a forklift or a crane.

5. The device of claim 1, wherein the elongated screw, the right bracket, the left bracket and the nut are each made from a metal or a metal alloy.

6. A method for removing a liner from a bucket wherein an elongated vice is used, the elongated vice comprising a brace, an elongated screw supported within the brace, and a right bracket and a left bracket that are connected together by the elongated screw, the method comprising the steps of:
placing the elongated vice over a top of the bucket and the liner;
positioning the right bracket and the left bracket on opposite sides of the bucket and so that each bracket is aligned with a gap created by the bucket and the liner;
turning a handle that is attached to a right end of the elongated screw thereby closing the vice and causing the right and left brackets to slide underneath the lip of the liner;
providing a lifting force underneath the brace; and,
lifting the vice and the liner so that the liner is lifted out of the bucket;
wherein, the left bracket includes a nut that is secured to central portion of the left bracket and a threaded end of the elongated screw passes through the nut.

7. The method of claim 6, wherein the right bracket and the left bracket each have a cross-sectional shape of an “L”, and the lower portion of both brackets point inward.

8. The method of claim 6, wherein the brace includes one or more attachment sites, wherein each attachment site allows for attachment of the lifting force to the brace.

9. The method of claim 6, wherein the lifting force is a forklift or a crane.

10. The method of claim 6, wherein the elongated screw, the right bracket, the left bracket and the nut are each made from a metal or a metal alloy.
